(19) United States
(12) Patent Application Publication
(10) Pub. No.: US 2019/0135698 A1
(43) Pub. Date: May 9, 2019

(54) ACTIVATORS AND METHODS FOR SETTING A JOINT COMPOUND

(71) Applicant: United States Gypsum Company, Chicago, IL (US)

(72) Inventors: Guy L. Rosenthal, Wheaton, IL (US); Charles J. Miller, Johnsburg, IL (US); Tyler Kincaid, Chicago, IL (US)

(21) Appl. No.: 15/805,854

(22) Filed: Nov. 7, 2017

(51) Int. Cl. C04B 28/14; C04B 22/14; C04B 40/00

(52) U.S. Cl. CPC C04B 28/148; C04B 22/142; C04B 2103/12; C04B 40/0042; C04B 22/148

(57) ABSTRACT

A kit for preparing a set activator blend and a method for controlling a setting reaction with the set activator blend of a setting joint compound, in particular of a ready-mixed setting joint compound, the method including: 1) blending together a first set activator including a cadmium compound, lead compound and/or zinc compound and a second set activator including a ferrous compound, aluminum compound and/or manganese compound, and thereby obtaining a set activator blend; and 2) mixing the set activator blend with the setting joint compound and thereby controlling the setting reaction of the setting joint compound.

### TECHNICAL FIELD

This invention relates to blends of a fast-acting set activator and a slow-acting set activator for setting and hardening joint compounds, and methods for controlling a setting reaction with the blends.

### BACKGROUND

Joint compounds are commonly used in building construction. One of the application is to patch a seam between two gypsum panels. Typically, interior walls are made by attaching gypsum panels (also referred to as wallboard) to studs. A joint compound is then used to fill and coat seams (also referred to as joints) between the gypsum panels.

Two types of joint compounds are known: a setting-type joint compound and a drying-type joint compound. Often, a setting-type joint compound comprises calcium sulfate hem ihydrate (also known as plaster of Paris or calcined gypsum). These compounds set via a setting reaction in which calcium sulfate hemihydrate hydrates into calcium sulfate dihydrate (gypsum).

A setting-type joint compound can be formulated as a dry powder which is mixed with water prior to an application. Adding water to the dry powder initiates conversion of calcined gypsum into gypsum, which triggers setting and hardening of the joint compound.

A setting-type joint compound can be also formulated as a wet ready-mixed joint compound. Such compounds are already pre-mixed with water, yet can be stored on a shelf for a period of time without a setting reaction by which calcined gypsum is converted into gypsum. In order to inhibit the setting reaction during storage and transportation, the wet ready-mixed joint compounds contain a retarder. An activator is then added to a ready-mixed joint compound in order to initiate a setting reaction. Various activators are known, including zinc sulfate as provided in U.S. Pat. No. 5,746,822 assigned to the United States Gypsum Company. However, large amounts of zinc sulfate may be needed or a setting reaction may proceed very slowly. Many attempts have been also made to use alum as an activator. However, it is difficult to control a setting reaction with alum because alum is considered to be incompatible with formulations comprising calcium carbonate, yet many joint compounds contain calcium carbonate.

Further difficulties in controlling a setting reaction may arise if a joint compound has to be used under a temperature lower than 15° C. because a setting reaction can be significantly slowed under these conditions even if an activator has been added.

Thus, there remains a need in the art for a set activator which can be used for controlling a setting reaction in a broad spectrum of joint compounds.

### SUMMARY

In one aspect, this disclosure provides a method for controlling a setting reaction of a setting joint compound. The method comprises the following steps:

blending together a first set activator selected from a cadmium compound, lead compound and/or zinc compound and a second set activator selected from a ferrous compound, aluminum compound and/or manganese compound, thereby obtaining a set activator blend; and

mixing the set activator blend with the setting joint compound and thereby controlling the setting reaction of the setting joint compound. The first set activator may be zinc oxide, zinc hydroxide and/or zinc salt and the second set activator may be aluminum oxide, aluminum hydroxide and/or aluminum salt. In particularly preferred embodiments of the method, the first set activator is zinc sulfate and the second set activator is alum. The method can be performed with a ready-mixed joint compound which comprises a set retarder selected from zinc hexametaphosphate, potassium tripolyphosphate, tetra sodium pyrophosphate, sodium tripolyphosphate, mono-ammonium phosphate, monobasic potassium phosphate, and any combination thereof. This method is suitable for a setting joint compound which comprises calcium carbonate, mica, talc and/or clays.

The method can be performed at a great range of temperatures, including from 40° F. to 95° F. In a particularly preferred embodiment of the method, the first activator is zinc sulfate and the second activator is alum, the joint compound comprises calcium carbonate and the mixing of the activator blend with the joint compound is performed at a temperature in the range from 40° F. to 75° F.

In further embodiments of the method, the step of blending the two activators comprises adjusting the ratio of the first activator to the second activator for a temperature at which the mixing step with the joint compound is performed.

In another aspect, the present disclosure provides a kit which comprises a first set activator in a first package and a second set activator in a second package, and an instruction manual. In the kit, the first set activator may be zinc sulfate and the second set activator may be alum. The instruction manual may provide a chart of ratios for a set activator blend as a function of temperature at which the activator blend is to be mixed with a joint compound.

### BRIEF DESCRIPTION OF THE DRAWINGS

FIG. 1 is a plot of a set time as a function of an amount of activator added.

FIG. 2 is a plot of a set time as a function of temperature and an amount of alum activator added.

FIG. 3 is a plot of a set time as a function of temperature and an amount of zinc sulfate added.

FIG. 4 is a plot of a set time as a function of temperature and an amount of a blend of alum and zinc sulfate added.

### DETAILED DESCRIPTION

This disclosure provides blends of two set activators. The blends are suitable for controlling a setting reaction of joint compounds in a great range of temperatures.

The term “set activator” refers to a compound which can activate, accelerate or otherwise speed up a setting reaction of calcium sulfate hem ihydrate in a joint compound comprising a calcium ion chelating agent. Set activators are compounds comprising cations which have a log K value higher than calcium, wherein “K” is the equilibrium constant of a chelating reaction. Compounds that may act as a set activator may comprise any of the following cations: ferric, mercury, cupric, nickel, cobalt, cadmium, lead, zinc, ferrous, aluminum, and manganese.

A blend of two set activators provided in this disclosure comprises a first set activator and a second set activator. The first set activator may be selected from a compound comprising any of the following cations: cadmium, lead and/or zinc. Suitable first activator compounds may be in the form of salts, oxides and/or hydroxides. Particularly preferred as the first set activator is a compound comprising zinc cations. Such zinc compounds include, but are not limited to, zinc oxide, zinc hydroxide and zinc salts. Suitable salts include, but are not limited to, zinc nitrate, zinc chloride, zinc chlorate, zinc sulfate, zinc sulfide, zinc phosphate, zinc molybdate, zinc chromate, and zinc acetate. A particularly preferred as the first activator is zinc sulfate. The general chemical formula for zinc sulfate is ZnSO₄. However, it will be understood that the term “zinc sulfate” in this disclosure also includes any of the three zinc sulfate hydrates, including zinc sulfate heptahydrate.

The second activator in the blend can be selected from a compound comprising any of the following cations: ferrous, aluminum and/or manganese. Suitable second activator compounds may be in the form of salts, oxides and/or hydroxides. Particularly preferred as the second activator is a compound comprising aluminum. Such aluminum compounds include, but are not limited to, aluminum oxide, aluminum hydroxide and aluminum salts. Suitable salts include, but are not limited to, aluminum chloride, aluminum sulfate, aluminum ammonium sulfate, and aluminum potassium sulfate. A particularly preferred as the second activator is aluminum sulfate. In this disclosure, the term “aluminum sulfate” is used interchangeably with the term “alum.” The chemical formula for aluminum sulfate which is also referred to as alum is Al₂(SO₄)₃. It will be understood that the term “aluminum sulfate or alum” also includes anhydrous aluminum sulfate and aluminum sulfate hydrates, including 18-hydrate aluminum sulfate.

A blend of the first activator and the second activator may comprise: 1) at least one compound selected from a cadmium compound, lead compound and/or zinc compound; and 2) at least one compound selected from a ferrous compound, aluminum compound and/or manganese compound. In the blend, the ratio of the first activator to the second activator may vary and it may be in the range from 99:1 to 1:99 by weight of the first activator to the second activator.

A set activator blend of the present disclosure can be used in any amount sufficient to activate a setting reaction in a joint compound. Typically, these blends can be used in an amount from 0.5% to 5% of a joint compound by weight of dry ingredients, water excluded.

Some blends of this disclosure may comprise zinc oxide, zinc hydroxide and/or zinc salt and a ferrous compound, aluminum compound and/or manganese compound.

At least some blends of this disclosure may comprise as the first activator zinc oxide, zinc hydroxide and/or zinc salt and also aluminum oxide, aluminum hydroxide and/or aluminum salt as the second activator.

Some blends of this disclosure may comprise a cadmium compound, lead compound and/or zinc compound and at least one of aluminum oxide, aluminum hydroxide and/or aluminum salt.

Some blends of this disclosure may comprise a zinc salt and aluminum oxide, aluminum hydroxide and/or aluminum salt.

A preferred set activator blend of this disclosure may comprise, contain, consist essentially of or consist of zinc sulfate as the first activator and aluminum sulfate as the second activator. In the blend, the ratio of the first activator to the second activator may vary and it may be in the range from 99:1 to 1:99 by dry weight of the first activator to the second activator. Most preferred ranges of zinc sulfate to aluminum sulfate are in the range from 3:1 to 1:1 by dry weight of zinc sulfate to aluminum sulfate. These preferred set activator blends can be used in an amount from 0.5% to 5% of a joint compound by weight of dry ingredients, water excluded.

A set activator blend of the present disclosure can be used to control a setting reaction of any setting joint compound formulated with or without a set retarder. A set activator blend of the present disclosure can be used to control a setting reaction of a ready-mixed joint compound which is formulated with a retarder. A set activator blend of the present disclosure can be also used to control a setting reaction of a setting joint compound formulated as a dry powder and mixed with water during the use. These dry-powder setting joint compounds may or may not comprises a retarder. If a set activator blend of the present disclosure is used to control a setting reaction of a setting joint compound which does not comprise a retarder, the activator blend is used as an accelerator to prevent foaming and accelerate the setting reaction.

The set activator blends of the present disclosure are particularly useful for controlling a setting reaction of a ready-mixed setting joint compound which comprises at least one set retarder. Such set retarders may include calcium-chelating agents. The set retarder can be any of non-calcium bearing phosphates, including zinc hexametaphosphate, potassium tripolyphosphate, tetra sodium pyrophosphate, sodium tripolyphosphate, mono-ammonium phosphate and/or monobasic potassium phosphate. Other set retarders may include a proteinaceous retarder, such as SUMA set retarder. Set retarders may also include any of low molecular weight polymers, such as a low molecular weight polyacrylate, including a co-polymer composition containing acrylic acid and acrylamide monomer units or a blend of an acrylic acid homo-polymer and an acrylamide homo-polymer.

The set activator blends of the present disclosure can be used to control a setting reaction in a setting joint compound with any of the set retarders (non-calcium bearing phosphates, proteinaceous retarders, low molecular weight polymers) which can be used individually or in combination with one another in any useful amount.

The set activator blends of the present disclosure can be used to control a setting reaction of a joint compound comprising any calcium sulfate hem ihydrate, including joint compounds which comprise calcium sulfate in the alpha-hem ihydrate form, calcium sulfate in the beta-hem ihydrate form, synthetic calcium sulfate hem ihydrate, and any combinations thereof.

The set activator blends of the present disclosure can be used to control a setting reaction of either light or conventional setting joint compounds. Suitable joint compounds include those which comprise calcium carbonate, mica, talc and/or clays.

The present set activator blends provide a choice of setting times which can be customized on demand at a construction site, depending on a time which is needed to complete a particular project and on a temperature at which a joint compound is to be used in the particular project.

A setting time of a setting joint compound depends on a temperature at which the setting joint compound is hardening. Typically, a setting reaction proceeds more slowly at a lower temperature. Thus, there may be a fluctuation in a setting time for wallboard installation projects completed during cold months when a temperature is below 60° F. and similar installation projects, but completed during summer months when a temperature is above 60° F. Under some circumstances, a setting reaction in a joint compound cannot be completed satisfactory with prior art activators at a temperature lower than 50° F.

One of the technical advantages provided by the present set activator blends is these blends can speed up a rate of a setting reaction at a lower temperature in the range from 40° F. to 60° F. Accordingly, an installation project can proceed under the same schedule despite a seasonal fluctuation in temperatures. Thus, the set activator blends provide important labor and material cost savings.

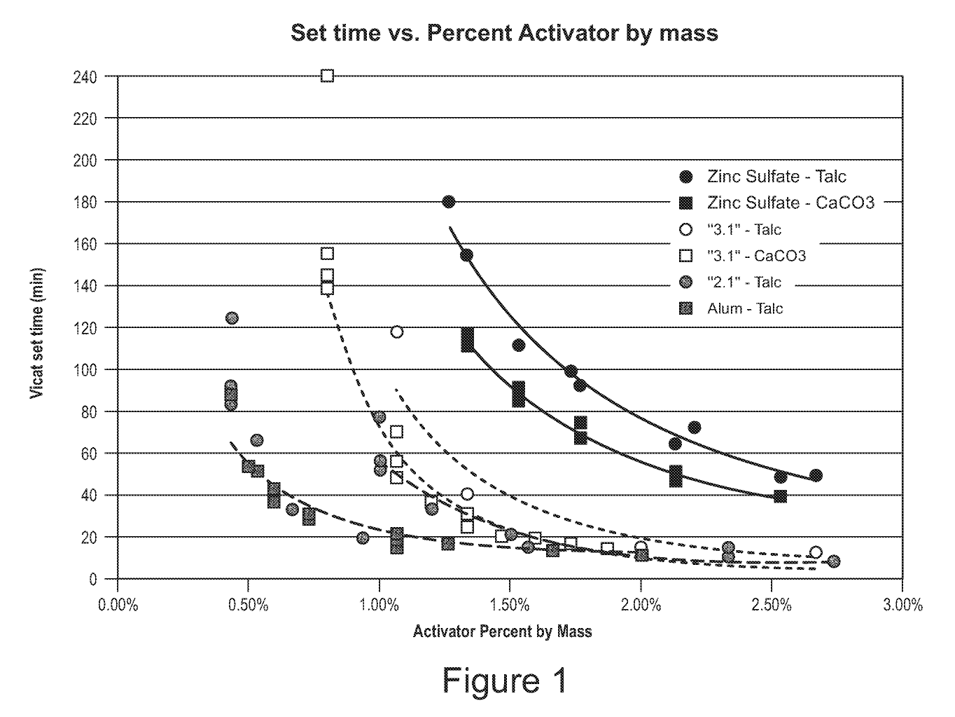

Referring to FIG. 1, it reports a set time for ready-mixed setting joint compounds as a function of the amount of a set activator added. The ready-mixed setting compounds comprise a set retarder. The set time is measured in minutes. The amounts of activators added are by mass % from the mass of dry ingredients in a joint compound, water excluded. As a control, zinc sulfate is tested for setting a joint compound comprising talc (curve 1) and also for setting a joint compound comprising calcium carbonate (curve 2). As another control, alum is tested for setting a joint compound comprising talc (curve 6). A setting reaction with alum proceeds much quicker than a reaction with zinc sulfate (compare curve 2 versus curve 6). Unexpectedly, a synergistic kinetics is uncovered in various setting reactions with a blend of zinc sulfate and alum. This synergistic effect is observed for both a setting compound comprising talc (see curve 3) and also a setting compound comprising calcium carbonate (see curve 4). The rate of a setting reaction can be tightly controlled by varying a ratio between zinc sulfate and alum (compare curve 3 of a setting reaction with the 3:1 ratio of zinc sulfate to alum to curve 5 of a setting reaction with the 2:1 ratio of zinc sulfate to alum).

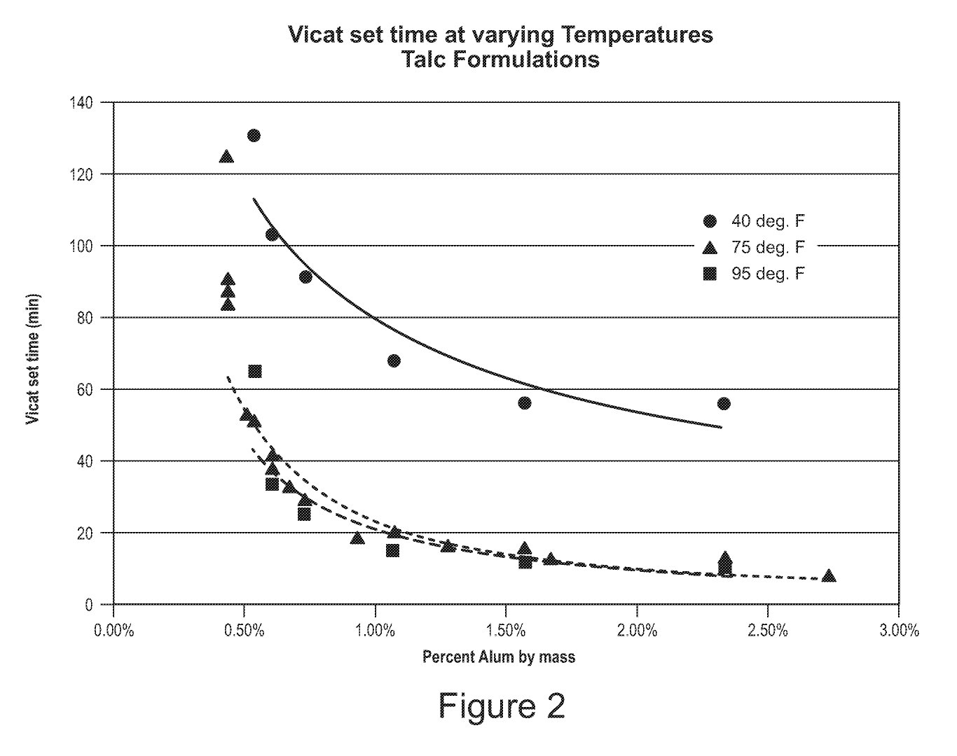

Referring to FIG. 2, it reports a set time as a function of temperature for ready-mixed setting joint compounds comprising talc and a set retarder. In these compounds, a setting reaction was initiated with various amounts of alum at 40° F. (curve 1), 75° F. (curve 2) or 95° F. (curve 3). While there is not much difference in a setting reaction performed at either 75° F. or 95° F. (curves 2 and 3, respectively), a setting reaction is significantly inhibited at 40° F. (curve 1). Yet, a set time of 60 minutes can be still achieved by increasing the amount of alum used.

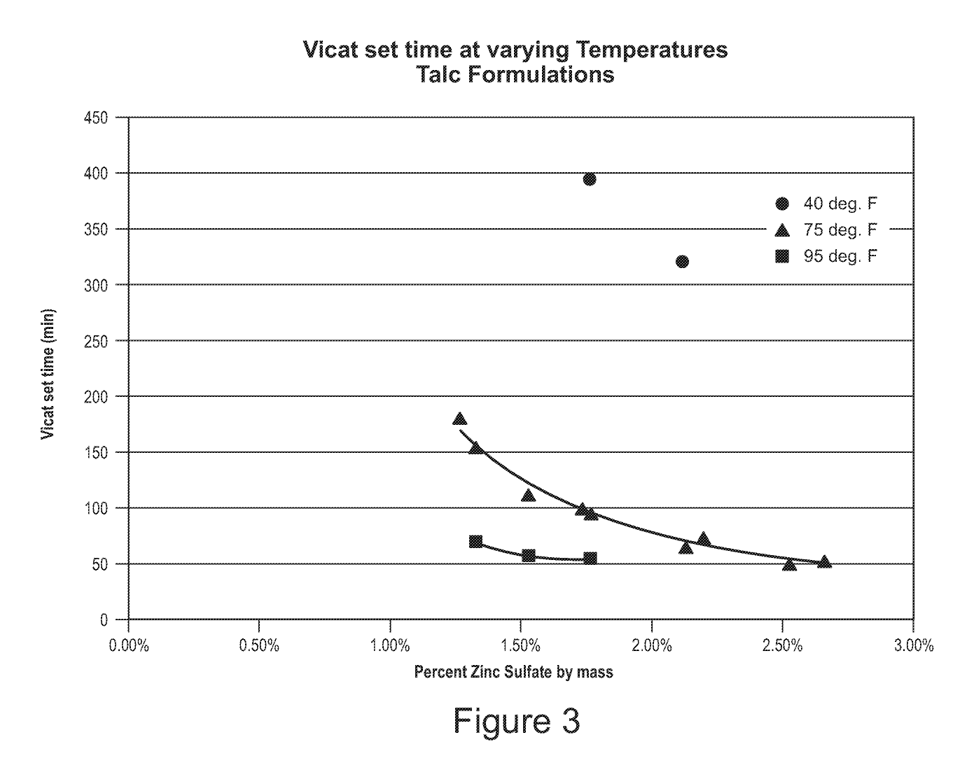

Referring to FIG. 3, it reports a set time as a function of temperature for ready-mixed setting joint compounds comprising talc and a set retarder. In these compounds, a setting reaction was initiated with various amounts of zinc at 40° F. (curve 1), 75° F. (curve 2) or 95° F. (curve 3). Unlike alum, zinc sulfate does not initiate setting reactions efficiently at 40° F. (curve 1). A significant difference in also observed in a rate of a setting reaction performed at 75° F. (curve 2) versus 95° F. (curve 3) if zinc sulfate is used in amounts of less than 2% by weight of dry components in a setting joint compound.

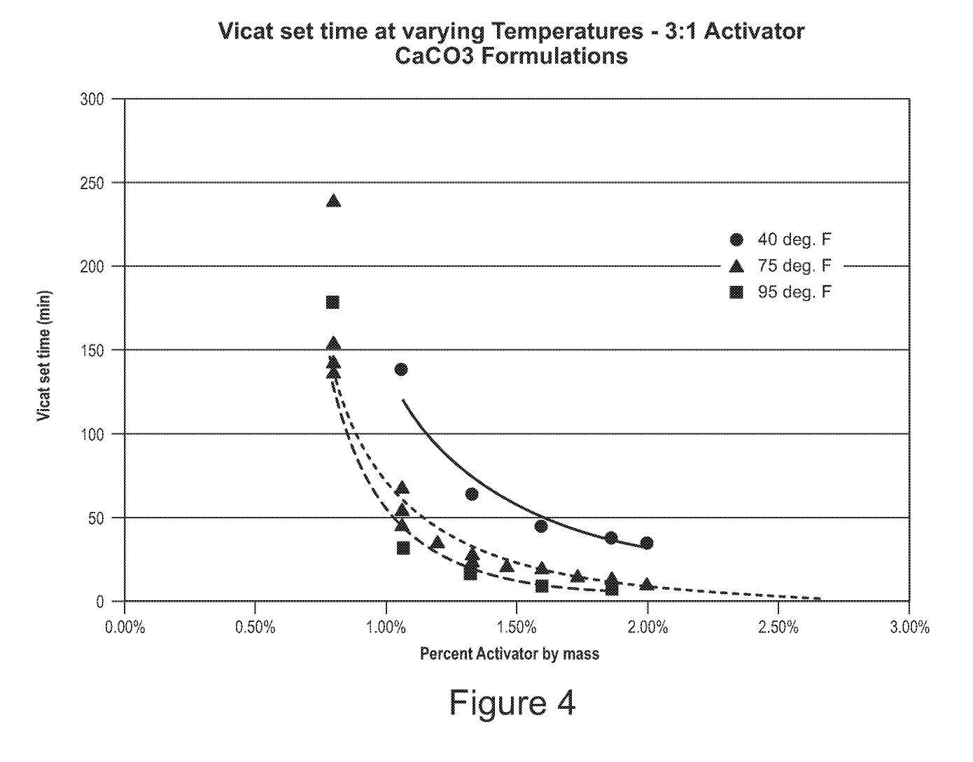

Referring to FIG. 4, it reports a set time as a function of temperature for ready-mixed setting joint compounds comprising calcium carbonate and a set retarder. In these compounds, a setting reaction was initiated with a blend of zinc sulfate and alum in 3:1 ratio respectively at 40° F. (curve 1), 75° F. (curve 2) or 95° F. (curve 3). Unlike alum, zinc sulfate does not initiate setting reactions efficiently at 40° F. (curve 1). Unlike zinc sulfate alone, a blend of zinc sulfate and alum activates a setting reaction at 40° F. very efficiently (curve 1). The blend also works very efficiently in amounts lower than zinc sulfate alone. Importantly, no significant adverse reaction with calcium carbonate was observed even as one of the activators in the blend was alum. This is also a significant improvement over reactions performed with alum alone.

In connection with FIGS. 1-4, Vicat set time is a period of time needed for a joint compound to solidify from the moment when an activator (or activator blend) is added to a ready-mixed setting joint compound. The set time is measured with a Vicat needle which is held vertically at the surface of a joint compound mixture and allowed to sink of its own weight into the mixture if the mixture has not solidified yet.

A set activator blend of the present disclosure may be sold as a kit comprising two activators, a first activator selected from a cadmium compound, lead compound and/or zinc compound in a first package and a second activator selected from a ferrous compound, aluminum compound and/or manganese compound in a second package. The kit may further comprise an instruction manual. The instruction manual can be in electronic format. The instruction manual may comprise charts providing the amount of the first activator and the second activator to be used in a blend depending on at least one of the following parameters: 1) a temperature at a construction site at the time of use; and/or 2) a set time needed.

In one aspect, the present disclosure provides a kit comprising zinc sulfate in a first package and alum in a second package. The kit may further comprise an instruction manual which lists ratios in which zinc sulfate and alum may be blended in order to achieve a needed set time at various temperatures.

In another aspect, the present disclosure provides a method for controlling a setting reaction of a setting joint compound at a broad range of temperatures. In the method, a setting reaction is controlled with any of the set activator blends of the present disclosure. Suitable joint compounds include ready-mixed setting joint compounds comprising at least one retarder. The retarder may be a calcium-free phosphate compound.

In further aspect, the present disclosure provides a method for controlling a setting reaction of a setting compound, including a ready-mixed setting compound, at a broad range of temperatures with a blend of zinc sulfate and alum. In the method, zinc sulfate and alum are blended together in a ratio in the range from 3:1 to 2:1 by dry weight of zinc sulfate to alum. The blend is then used in an amount from 0.5% to 3% by weight of a joint compound, excluding water. The method can be performed at a temperature in the range from about 40° F. to about 95° F. The method can be performed with various setting joint compounds, including ready-mixed setting joint compounds comprising at least one retarder. The retarder may be calcium-free phosphate compound. The method can be performed with either a conventional or light-weight setting joint compound comprising perlite, expanded perlite, vermiculate, or any combination thereof.

1. A method for controlling a setting reaction of a setting joint compound, the method comprising:
blending together a first set activator comprising a cadmium compound, lead compound and/or zinc compound and a second set activator comprising a ferrous compound, aluminum compound and/or manganese compound, and thereby obtaining a set activator blend; and
mixing the set activator blend with the setting joint compound and thereby controlling the setting reaction of the setting joint compound.

2. The method of claim 1, wherein the first set activator is zinc oxide, zinc hydroxide and/or zinc salt and wherein the second set activator is aluminum oxide, aluminum hydroxide and/or aluminum salt.

3. The method of claim 1, wherein the first set activator is zinc sulfate and wherein the second set activator is alum.

4. The method of claim 1, wherein the first set activator is zinc sulfate and wherein the second set activator is alum, and wherein the zinc sulfate and alum are used in a ratio in the range from 3:1 to 1:1 by dry weight of zinc sulfate to alum.

5. The method of claim 1, wherein the first set activator is zinc sulfate and wherein the second set activator is alum, and wherein the zinc sulfate and alum are used in a ratio in the range from 3:1 to 1:1 by dry weight of zinc sulfate to alum and wherein the set activator blend is mixed with the setting joint compound in an amount in the range from 0.5% to 5% by weight of dry ingredients in the setting joint compound.

6. The method of claim 1, wherein the setting joint compound is a ready-mixed joint compound and comprises a set retarder comprising zinc hexametaphosphate, potassium tripolyphosphate, tetra sodium pyrophosphate, sodium tripolyphosphate, mono-ammonium phosphate, monobasic potassium phosphate, and any combination thereof.

7. The method of claim 1, wherein the setting joint compound comprises calcium carbonate, mica, talc and/or clays.

8. The method of claim 1, wherein the mixing is performed at a temperature in the range from 40° F. to 95° F.

9. The method of claim 1, wherein the first activator is zinc sulfate and the second activator is alum, the joint compound comprises calcium carbonate and the mixing is performed at a temperature in the range from 40° F. to 75° F.

10. The method of claim 1, wherein the first activator is zinc sulfate and the second activator is alum, the ratio of zinc sulfate to alum is from 3:1 to 1:1 by dry weight, the joint compound comprises calcium carbonate and the mixing is performed at a temperature in the range from 40° F. to 65° F., and wherein the set activator blend is added in an amount from 0.5% to 5% by weight to the setting joint compound, excluding water.

11. The method of claim 1, wherein the step of blending comprises adjusting the ratio of the first activator to the second activator for a temperature at which the mixing step is performed, and wherein the ratio shifts to increasing the proportion of the second activator as the temperatures decreases.

12. A kit for making a set activator blend, the kit comprising a first set activator in a first package and a second set activator in a second package, and an instruction manual.

13. The kit of claim 12, wherein the first set activator is zinc sulfate and the second set activator is alum.

14. The kit of claim 12, wherein the instruction manual provides a chart of ratios for the set activator blend as a function of temperature at which the blend will be mixed with a setting joint compound.
